(19) United States
(12) Patent Application Publication
(10) Pub. No.: US 2006/0187776 A1
(43) Pub. Date: Aug. 24, 2006

(54) Information recording and reproducing apparatus and method for controlling positions of optical pickup device and objective lens used for the apparatus

(76) Inventors: Hideaki Okano, Yokohama-shi (JP); Kazuo Watabe, Yokohama-shi (JP); Sumitaka Maruyama, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/345,647

(22) Filed: Jan. 31, 2006

(30) Foreign Application Priority Data
Jan. 31, 2005 (JP) 2005-024479

(51) Int. Cl. G11B 7/00

(52) U.S. Cl. 369/44.28

(57) ABSTRACT

According to one embodiment, an optical pickup according to the present invention has a servo circuit in which, when Tp is a track pitch of an optical disk, NA is the numerical aperture of an objective lens, and Fp is a detection range of a focus error, a focus detection range defined in a range of 2Tp/(NA×Fp)<0.6 is assigned. In this manner, it is possible to reduce the cases where focus control becomes unstable due to leakage of a track error signal into a focus error signal. Therefore, an optical disk recording and reproducing apparatus which is less likely to malfunction can be obtained by using this optical pickup.

### CROSS-REFERENCE TO RELATED APPLICATIONS

This application is based upon and claims the benefit of priority from Japanese Patent Application No. 2005-024479, filed Jan. 31, 2005, the entire contents of which are incorporated herein by reference.

### BACKGROUND

1. Field

One embodiment of the invention relates to an optical disk recording and reproducing apparatus (information recording and reproducing apparatus) for recording, erasing, or reproducing information on an optical disk capable of recording, erasing or reproducing information by using a laser beam. In addition, the present invention relates to a method for controlling positions of an optical pickup device and an objective lens used for the information recording and reproducing apparatus.

2. Description of the Related Art

Conventionally, an optical disk has been widely used as a recording medium suitable for recording information.

An optical disk recording and reproducing apparatus for recording information in an optical disk or reproducing the recorded information, or alternatively, erasing the already recorded information includes: an optical transmission system for irradiating laser beams, each having a predetermined wavelength, to a recording face of an optical disk at a predetermined position of an optical disk (recording medium); an optical receiving system for detecting the laser beams reflected on the optical disk; a mechanical section represented by a disk motor, a disk loading mechanism and the like; a mechanism control (servo) system for controlling a respective one of the optical transmission system, the optical receiving system, and the mechanical section; a signal processing system for supplying information to be recorded or an erasing signal to the optical transmission system and reproducing information recorded from the signal detected by means of the optical receiving system; or the like.

The optical transmission system and the optical receiving system include: a laser diode (LD) which is a light source for outputting a laser beam; and an objective lens for focusing the laser beam from the LD onto a recording face of an optical disk and for capturing the laser beams reflected by the optical disk. These systems are called an optical head or an optical pickup.

In recording information on an optical disk, reproducing the recorded information from the optical disk, or erasing the information, a position at which a laser beam is currently irradiated is specified on the optical disk via an objective lens from a guide groove (track) specific to the optical disk or the number of recording mark (pit) columns.

That is, the laser beams irradiated to the optical disk by means of the optical pickup receive reflected laser beams reflected on the optical disk. The received light beams are converted into electrical signals. Then, components indicating tracks or recording mark columns are counted. In this manner, a position (of the optical pickup) in the tracks or recording mark columns to which the laser beams are currently irradiated via the objective lens is specified. In addition, in the case where the optical disk is a disk in which information such as a track number has been recorded, there is a widely utilized system of setting the object lens at an on-track/just-focus state, and directly reading the track number.

It is disclosed by, for example, Japanese Patent Application Publication (KOKAI) No. 2003-162826, for the case where an objective lens is moved to a target track, the target track being distant from a track in which laser beams are currently irradiated, there is proposed a method of turning off a track servo and moving an objective lens (optical head) while only a focus servo is made active. There is a description that, according to this method, the number of tracks is counted based on a tracking error signal obtained when crossing a track, whereby a current track can be smoothly moved to a target track.

However, in the method for counting the number of tracks from the tracking error signal, as described in the above publication, it is known that a focus error signal becomes unstable, and a focus is easily out of order because a tracking error signal leaks into a focus error signal. Thus, in the method described in the above mentioned publication, there is a need for measuring an amount of the tracking error signal leaking into the focus error signal (amount of leakage), and correspondingly, providing an offset of a predetermined quantity to the focus control signal. If the offset size exceeds a predetermined value, the focus detection sensitivity is degraded, thus making it necessary to stabilize the focus servo while the gain of the focus servo is made variable.

In addition, in the method described in the above publication, in the case where a position of an optical spot when starting the focus servo is a specific position with respect to the optical disk tracks or recording mark columns, diffraction or scattering occurs to laser beams (optical spots), and the amount of the tracking error signal leaking into the focus error signals may change extremely. In this case, there is a problem that the focus error signal is distorted and the focus servo cannot be started.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic view showing an example of a configuration of an information recording and reproducing apparatus (optical disk apparatus) which can be applied according to an embodiment of the invention;

FIG. 2 is an exemplary schematic view showing an example of a configuration of an optical pickup in the optical disk apparatus according to an embodiment of the invention shown in FIG. 1;

FIG. 3 is an exemplary schematic view showing an example of a pattern of optical flux division and a pattern of an optical receiving region of a photodiode by means of a hologram for use in the optical pickup according to an embodiment of the invention shown in FIG. 2;

FIG. 4 is an exemplary graph showing an example of an output from a focus detection optical receiving region of the photodiode for use in the optical pickup according to an embodiment of the invention shown in FIG. 2;

FIGS. 5A and 5B are exemplary schematic views each showing an example of an overlap between a 0th-order light beam and ±1st-order light beam of laser beams diffracted by a groove (recessed portion) or a land (other than recessed portion) of a track on a recording face of an optical disk according to an embodiment of the invention;

FIGS. 6A to 6F are exemplary photographs each showing an output obtained by computation (simulation) of an intensity distribution of reflected laser beams, each of which is adopted to explain effect of the cycles of the land and groove on a focus error signal according to an embodiment of the invention;

FIG. 7 is an exemplary graph depicting a relationship of intensity and defocus quantity of laser beams having transmitted a region for a focus error signal of the hologram for use in the optical pickup according to an embodiment of the invention shown in FIG. 2;

FIG. 8 is an exemplary graph depicting an example of an output obtained by changing a detection range (defocus range) of a focus error caused by a focus detection optical receiving region of a photodiode for use in the optical pickup according to an embodiment of the invention shown in FIG. 2; and

FIG. 9 is an exemplary graph depicting an example (formula (4)) of a suitable range in the detection range of the focus error.

### DETAILED DESCRIPTION

Various embodiments according to the invention will be described hereinafter with reference to the accompanying drawings. In general, according to one embodiment of the invention, an optical pickup according to the present invention has a servo circuit in which, when Tp is a track pitch of an optical disk, NA is the numerical aperture of an objective lens, and Fp is a detection range of a focus error, a focus detection range defined in a range of 2Tp/(NA×Fp)<0.6 is assigned. In this manner, it is possible to reduce the cases where focus control becomes unstable due to leakage of a track error signal into a focus error signal. Therefore, an optical disk recording and reproducing apparatus which is less likely to malfunction can be obtained by using this optical pickup.

According to an embodiment, FIG. 1 shows an example of a configuration of an information recording and reproducing apparatus (optical disk apparatus) which can be applied in an embodiment of the present invention.

An optical disk apparatus 1 shown in FIG. 1 focuses laser beams irradiated from an optical pickup (PUH actuator) 10 into an information recording layer of an optical disk D, thereby making it possible to record information in the optical disk D and to reproduce the information from the optical disk D.

The laser beams reflected from the optical disk D are detected as an electrical signal by means of a photodetector (PD) 11 of the PUH 10. An output signal from the PD 11 is amplified by means of a preamplifier 12. The amplified signal is output to a servo circuit (lens position control device) 101 connected to a controller (lens position control quantity setting device (main control device)); an RF signal processor circuit (output signal processor circuit); and an address signal processor circuit 103.

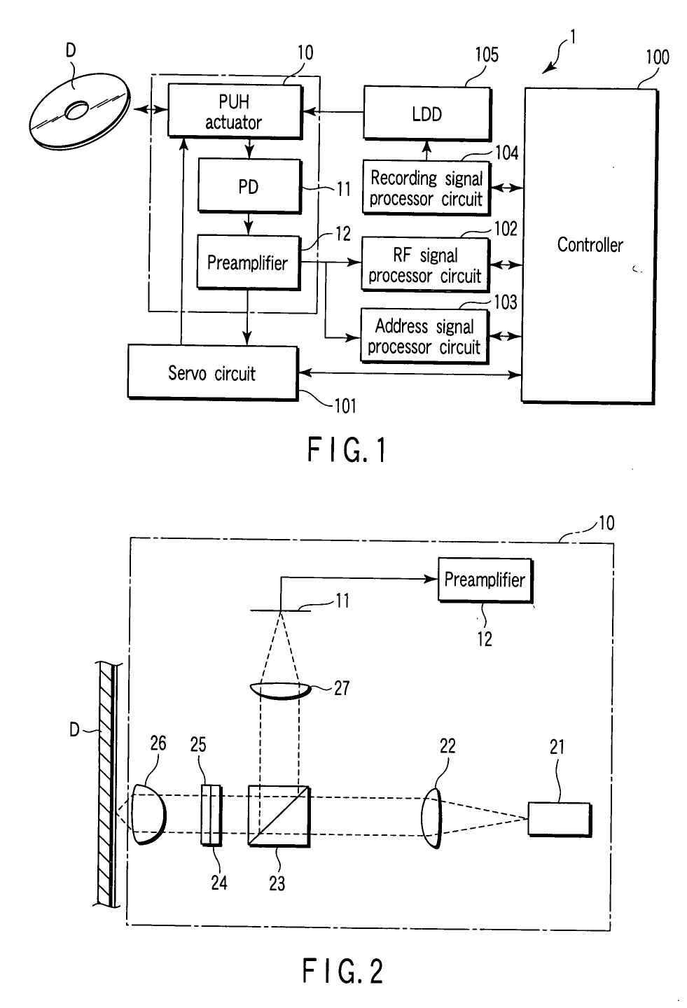

In the servo circuit 101, although described later in detail with reference to FIG. 2, a focus servo signal of an objective lens mounted on the PUH 10 (for controlling a distance between a recording layer of an optical disk D and an objective lens with respect to a focal position of the objective lens) and a tracking servo signal (for controlling a position in a direction crossing a track of the optical disk D of the objective lens) are generated. These signals are output to a focus actuator and a tracking actuator (lens position control mechanism) of the PUH 10, although not shown, respectively.

In the RF signal processor circuit 102, user data or management information is captured from a signal detected and reproduced by means of the PD 11. In the address signal processor circuit 103, address information, i.e., information indicating a track or a sector of the optical disk D in which the objective lenses of the PUH 10 are currently opposed to is captured, and the captured information is output to the controller 100.

In the controller 100, in order to read out data such as user data of a desired position or in order to record user data or management information at a desired position based on the address information, the position of the PUH 10 is controlled.

In the controller 100, during information recording or reproduction, the intensity of the laser beams output from a laser element (LD) is indicated. By means of the indication from the controller 100, it is possible to erase the data which has already been recorded in an address (track or sector) of a desired position.

When information is recorded in an optical disk, (under the control of the controller 100), in the recording signal processor circuit 104, the recording data modulated to a recording waveform signal suitable for optical disk recording, i.e., a recording signal is supplied to a laser drive circuit (LDD) 105. From the laser element of the PUH 10, a laser beam whose intensity has been changed in response to information to be recorded is output in response to a laser drive signal supplied from the LDD 105. In this manner, information is recorded in the optical disk D.

FIG. 2 shows an example of a configuration of the PUH (optical pickup, i.e., optical head) of the optical disk apparatus 1 shown in FIG. 1.

The PUH 10 includes an LD, i.e., a light source 21, which is a semiconductor laser element, for example. The wavelength of the laser beam output from the LD 21 ranges from 400 to 410 nm, for example, and preferably is 405 nm.

The laser beams from the LD (light source) 21 are collimated (produced as parallel light beams) by a collimator lens 22. In addition, the collimated light beams pass through a polarizing beam splitter (PBS) 23 provided in advance at a predetermined position; an optical splitter element, i.e., a hologram plate (HOE) 24 and a ¼ wavelength plate (polarizing control element) 25, and is captured by a focusing element, i.e., an objective lens (OL) 26. Predetermined convergence property is provided by the objective lens 26 to the laser beams captured by the objective lens 26 (The laser beams irradiated from the LD 21 are guided to the OL 26, and a minimum optical spot is exhibited at a focal position of the OL 26). The objective lens (OL) 26 is made of a plastics, for example, and its numerical aperture (NA) is 0.65, for example.

The laser beams reflected on an information recording face of the optical disk D are captured by the objected lens 26. Approximately parallel sectional beams are provided to the reflected beams, and the resulting beams are returned to the polarizing beam splitter 23. The reflected laser beams reflected from the optical disk D are changed by 90 degrees in polarization directions of the laser beams which go to the optical disk D by means of the ¼ wavelength plate 25. In addition, when the reflected laser beams are passed through the HOE 24, they are divided into a predetermined number in response to arrangement of detection regions which are provided in advance to the photodetector (PD) 11.

The reflected laser beams returned to the polarizing beam splitter 23 are reflected by the polarizing beam splitter 23 as a result of 90-degree rotation of the polarizing direction by means of the ¼ wavelength plate 25, and the reflected laser beams are formed as an image on an optical receiving face of the photodetector 11, by means of a focus lens 27.

In more detail, the laser beams emitted from the semiconductor laser (LD) 21 are collimated by a collimator lens 22. These laser beams are beams which are polarized straightway, and transmits the PBS (polarizing beam splitter) 23 and the hologram (HOE) 24. Then, a polarizing face is changed (rotated) to a circular polarized light by means of the ¼ wavelength plate 25, and the changed polarized light is focused on the optical disk D by the objective lens 26.

The laser beams focused on the optical disk D are modulated by pits, marks, or grooves and the like recorded in the optical disk.

The reflected laser beams reflected or diffracted on the recording face of the optical disk D are substantially made parallel to each other again by the objective lens 26. Then, the resulting laser beams are passed through the ¼ wavelength plate 25; the passed light beams are changed by 90 degrees in a polarization direction with respect to a forward passage, and the changed light beams are returned to the hologram 24. The hologram 24 is a hologram which acts only on polarized light (reflected laser beams) of a backward passage, and the laser beams (reflected laser beams) of the backward passage are divided into a plurality of luminous fluxes, and the divided light beams are deflected in a predetermined direction. (A distance from a center is changed with respect to an optical receiving region of a photodetector provided in association with the respective laser beams for each of the divided laser beams).

In this manner, the direction of the polarized lights is changed by 90 degrees, and the reflected laser beams divided into a predetermined number are reflected on the polarizing face of the PBS (polarizing beam splitter) 23, and the reflected light beams are focused on a respective optical receiving region (described later) of the photodetector 11 via the lens 27.

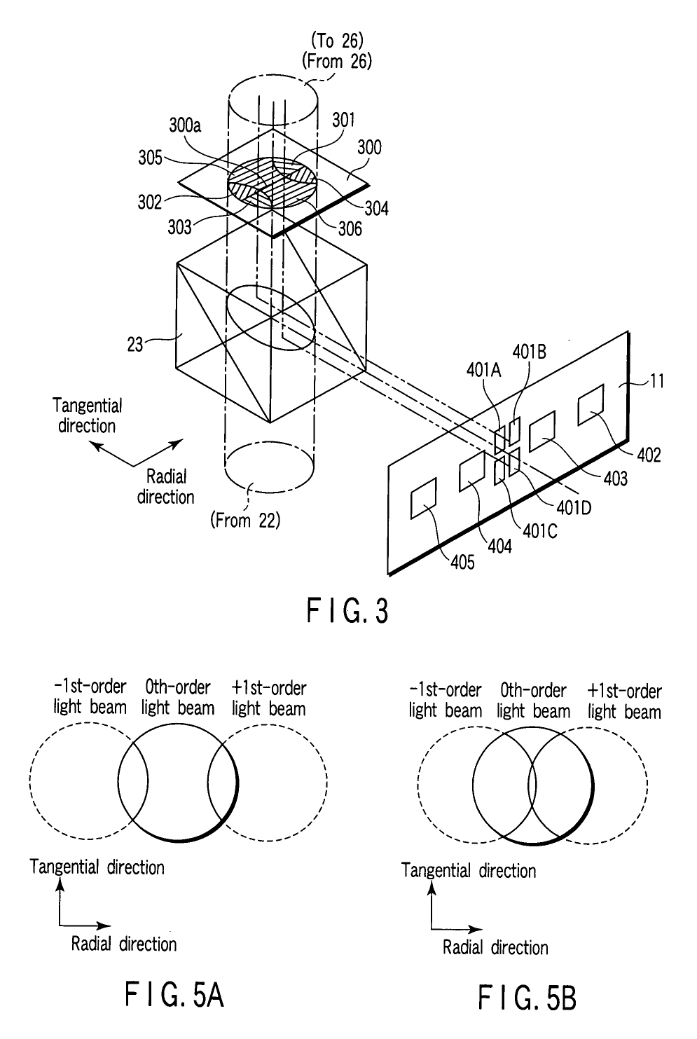

FIG. 3 shows an example of a pattern of luminous flux division by a hologram for use in the PUH shown in FIG. 2 and a pattern of an optical receiving region of a photodiode (PD).

As shown in FIG. 3, the hologram (HOE) 24 has a pattern 300 which has been formed in approximately circular shape, for example. The pattern 300 is segmented into a group of 301, 305, and 302 by a boundary 300a approximately passing through a center and a set of 302, 306, and 304 segmented in the same manner.

The patterns 301 to 304 are provided as regions for obtaining a tracking error signal. The laser beams having transmitted these regions are diffracted at an angle which is different from each other.

The respective patterns 301 to 304 (two pairs sandwiching boundary 300a) is formed so that the laser beams having passed through these patterns can be formed as an image in detection (optical receiving) regions 402 to 405 of the photodetector 11. The light beams having passed through the patterns 301, 302, and 303 are formed as an image in the regions 402, 405, and 404, respectively.

Therefore, for example, when the intensity of a signal generated by each of the optical receiving regions 402 to 405 ranges from P402 to P405, a push-pull signal is obtained in accordance with computation using the formula below:
(P402+P403)−(P404+P405) (1)

In addition, a tracking error signal using a differential phase detection technique (DPD technique) is obtained in accordance with computation using the formula below:
Ph(P402+P404−Ph(P403+P405) (2)

On the other hand, hologram patterns (regions) 305 and 306 (a pair sandwiching the boundary 300a) are provided as regions for obtaining a focus error signal, and these patterns are diffracted at an angle which is different from each other.

The respective patterns 305 and 306 are formed so that the laser beams passing through these patterns can be formed as an image on the detection (optical receiving) regions 401A to 401D of the photodetector 11.

The laser beams having transmitted through these regions 305 and 306 are focused in the detection regions 401A to 401D, for example, respectively. For example, a focal distance of the focus lens 27 and a distance or the like between each of the patterns 305 and 306 of the HOE 204 and each of the focus lens 27 and the photodetector 11 are set so that optical spots of the reflected laser beams are formed as an image between the optical receiving regions 401A and 401B and between the detection regions 401C and 401D, whereby a focus detecting system called a knife edge technique is formed. The knife edge technique is provided as a detection method in which, in the case where a distance between the objective lens 26 and an information recording layer of the optical disk D coincides with a focal position (converged at a lens focal position) which exhibits a minimum beam spot due to the convergence property provided to the laser beams by means of the objective lens 26, the optical spot of the reflected laser beam is defined so that two groups are formed as an image between the optical receiving regions 401A and 401B and the detection regions 401C and 401D.

Here, when the signal intensity generated by the individual optical receiving regions 401A to 401D of the photodetector 11 is P401A to P401D, in accordance with computation using the formula below, it is possible to obtain a signal having an S-letter characteristic:
(P401A+P401D)−(P401B+P401C) (3)

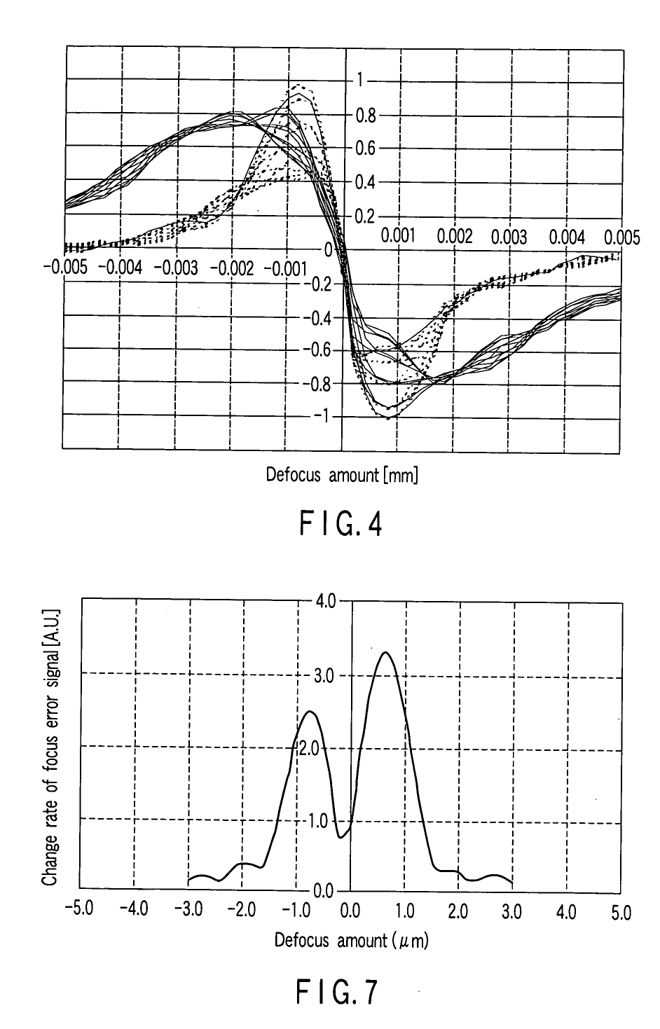

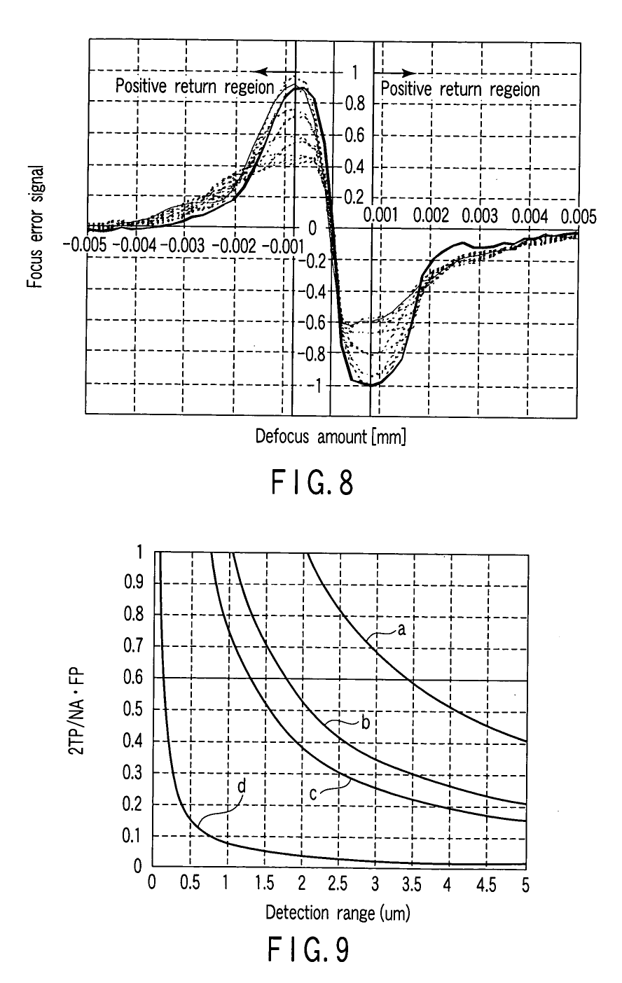

For example, as shown in FIG. 4 (or as seen in FIG. 8 explained in later paragraph), an output changes in response to a defocus quantity and the signal has an S-letter characteristic in which polarity is inverted in front of and at the depth side of a position at which a distance between he objective lens 26 and the information recording layer of the optical disk D exhibits a minimum beam spot provided to the laser beams by means of the objective lens 26.

That is, when an optical spot of the optical disk D is defocused (as the spot becomes distant from a position at which a minimum beam spot is exhibited), an optical spot formed as an image in the individual detection region of the photodetector is also defocused (the optical spot becomes large in size). For example, a positive side peak having its S-letter characteristic shown in FIG. 4 indicates that most of the laser beams having transmitted through a region 305 of the HOE 24 are formed as an image in the detection region 401A, and most of the laser beams having transmitted through a region 306 are formed as an image in the detection region 401D. Similarly, a negative side peak having its S-letter characteristic indicates that the laser beams having transmitted through a respective one of the regions 305 and 306 are formed as an image in the detection regions 401B and 401C.

Therefore, it is preferable that the focus detection range be defined wider than an interval described later with respect to FIG. 7, i.e., an interval between peaks.

FIGS. 5A and 5B each show a degree of an overlap between a 0th-order light beam and a ±1st-order light beam of the laser beams diffracted by a track (i.e., groove (recessed portion)) or a land (other than recessed portion) of a recording face of the optical disk D.

In the case of a reproduction only disk or a write-once type disk, groove recording or land recording is conducted, and a land or a groove which is not used for recording (in which no recording mark is formed) is narrow in width as compared with a groove or a land used for recording. Thus, a diffraction angle of the ±1st-order light beam increases, and is produced as shown in FIG. 5A, for example.

On the other hand, in particular, in the case of a rewritable optical disk, in order to improve recording density, information is recorded in both of a land and a groove. Therefore, unlike a reproduction only disk or a write-once type disk, the land and groove are equal in width (i.e., are wide as compared with the width of the land or groove which is not used for recording of the reproduction only disk or write-once type disk). As a result, the track cycle becomes larger than that of a reproduction only (ROM) disk or the write-once type disk, and a diffraction angle of the ±1st-order light beam becomes narrower. Thus, as shown in FIG. 5B, an overlay region between the diffraction light beam and the 0th-order light beam due to the land and groove increases in size. This denotes that effect on focusing is increased.

Hereinafter, a description will be given with respect to how a land and groove cycle has effect on a focus error signal.

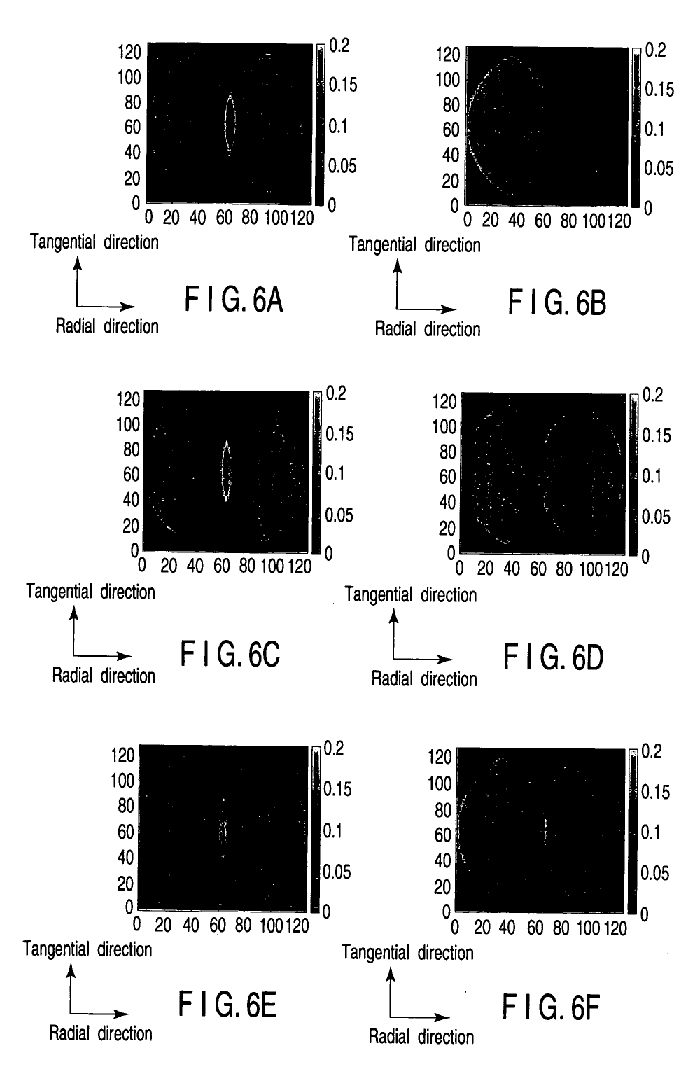

FIGS. 6A to 6F each show a result of computation (simulation) of an intensity distribution of the reflected laser beams reflected or diffracted after being focused on a recording face of an optical disk, assuming a rewritable optical disk which serves as an HD DVD, featured in that track pitch Tp is 0.34 μm; wavelength λ of a recording/reproducing laser beam is 405 nm; and aperture number NA of objective lens is 0.65. According to the present invention, because of land-groove recording, the track pitch Tp indicates either of a land and a groove, and from one groove to a next groove or from a land to a next land is designated by 2Tp.

FIGS. 6A and 6B each show a case in which a focal position of an optical spot is just on a recording face of an optical disk, i.e., show an intensity distribution in which a defocus quantity is 0 μm (at the time of just focusing). FIG. 6A shows a case in which an optical spot is set at the center of a groove or a land, and FIG. 6B shows a case in which the spot is intermediate between a groove and a land.

FIGS. 6C and 6D each show a case in which a focal position of an optical spot is spaced by 1.0 μm from a recording face of an optical disk, i.e., show an intensity distribution when a defocus quantity is 1.0 μm. FIG. 6C shows a case in which the optical spot is set at the center of a groove or a land, and FIG. 6D shows a case in which the spot is intermediate between a groove and a land.

FIGS. 6E and 6F each show a case in which a focal position of an optical spot is spaced by 2.0 μm from a recording face of an optical disk, i.e., show an intensity distribution when a defocus quantity is 2.0 μm. FIG. 6E shows a case in which the optical spot is set at the center of a groove or a land, and FIG. 6F shows a case in which the spot is intermediate between a groove and a land.

As shown in FIGS. 6A and 6B, in the case where the defocus quantity is 0, a push-pull operation in which intensity changes differentially appears depending on where a whole region in which a 0th-order light beam and a ±1st-order light beam overlay is set in a radial direction of an optical spot, i.e., at which position the optical spot is set with respect to a land and a groove.

On the other hand, as shown in FIGS. 6C and 6D, when the defocus quantity becomes 1.0 μm, an interference stripe appears in a region in which the 0th-order light beam and the ±1st-order light beam overlap each other, and an intensity distribution occurs in the radial direction. Further, depending on a position of the optical spot, a peak of the interference stripe moves in the radial direction, although an interval between the interference stripes does not change.

In addition, as shown in FIGS. 6E and 6F, when the defocus quantity becomes 2.0 μm, an interference stripe appears in a region in which the 0th-order light beam and the ±1st-order light beam overlap each other, which is analogous to the case in which the defocus quantity is 1.0 μm. In this case, an interval (pitch) of the interference strips becomes approximately half as compared with the case in which the defocus quantity is 1.0 μm.

As described above, when the reflection or diffraction laser beams which change in intensity distribution are divided by means of a hologram having a division pattern as shown in FIG. 3, a region in which the 0th-order light beam and the ±1st-order light beam overlap each other enters the patterns 305 and 306 utilized to generate a focus error signal.

Therefore, the intensity of each of the laser beams which transmit the regions 305 and 306 for a focus error signal changes when an optical spot crosses a land and a groove (cross a track). In addition, an interval between the interference stripes generated in the region between the 0th-order light beam and the ±1st-order light beam overlap each other changes depending on a change of a defocus quantity. Thus, a change rate (laser light intensity) depends on the defocus quantity.

FIG. 7 is a graphical view showing how this change occurs in accordance with computation. The horizontal axis denotes a defocus quantity, and the vertical axis denotes a change rate.

From FIG. 7, in the case where the defocus quantity is +1 μm or −1 μm, it is observed that the change rate takes a peak. In general, in the case where a focus servo is started, a focus detecting operation is executed such that an objective lens becomes close to an optical disk after being distant from a recording face of the optical disk.

As a focal position of an optical spot becomes closer to the recording face of the optical disk, the S-letter characteristic as indicated by the solid line shown in FIG. 8 is detected, and it is detected that a positive return region has been entered. Thus, after the positive return region has been passed and if a focus servo is turned on until an opposite positive return region has been entered, the focus servo is obtained while the focus position of the optical spot becomes close to the recording face of the optical disk. That is, a distance between the optical disk and the objective lens is made to coincide with a minimum position of the optical spot defined at the focal position of the objective lens.

In the meantime, in a case in which the change as shown in FIG. 7 occurs, if a change peak is close to a peak of a focus error signal, the focus error signal greatly changes as shown in FIG. 4. In FIG. 4, the horizontal axis denotes a defocus quantity, and the dashed line indicates a focus error signal affected by a change of the defocus quantity. The dashed line indicates a focus error signal from a region in which a track exists (when an optical spot has been moved by two tracks in a radial direction from a position at which the result indicated by the solid line has been obtained).

That is, even if the defocus quantities are equal to each other, it is observed that a focus error signal level changes depending on a position on an optical disk at which an optical spot is traced (irradiated) (depending on whether or not the optical spot is set at a position affected by diffraction from a track).

Although described from formula (3), in the case where the defocus is 0 μm, the change is offset, whereby a change of a focus error signal is reduced. However, the peak or its vicinity of the focus error signal is easily affected by such change. That is, in the case where a change of the focus error signal occurs at a peak of the focus error, as has already been described, there can occur a problem that a focus servo cannot be started. In other words, with respect to a focus error signal at a position at which a track (land and groove) exists, its size changes, thus making it impossible to precisely detect a positive return region. In addition, when the change further increases, it is predicted that a focus error signal cannot be obtained at all.

In view of such a background, according to the present invention, effect of a change is reduced by widening a focus detection range, i.e., by widening a peak interval of the focus error signal.

FIG. 8 shows a result obtained by computing a focus error signal whose detection range is different from each other.

In FIG. 8, the dashed line denotes a case in which a focus error signal peak is close to a change peak, and the solid line denotes a case in which a defocus detection range has been widened. From FIG. 8, it is observed that a change rate is reduced in the case where the focus detection range has been widened, and that a change of a peak level is suppressed, which is important for discriminating a positive return region.

It is evident from FIGS. 6A to 6F described previously that a peak position of a change rate of the laser beams transmitting focus regions (regions 305 and 306 in FIG. 3) of a hologram (HOE) has a relationship with an interval between interference strips which appear in a region in which an 0th-order light beam and a ±1st-order light beam mainly overlap each other.

Therefore, the detection range in which effect of the change is reduced is obtained as a region defined by the formula below:
2Tp/(NA×Fp)<0.6 (4)

where Tp is a track pitch of an optical disk; NA is a numerical aperture of an objective lens; and Fp is a detection range of a focus error.

“2Tp” used when 0.6>2Tp/(NA×Fp) denotes land-groove recording according to the present invention, as described previously; track pitch Tp denotes either of a land and a groove; and a track pitch from a groove to a next groove or from a land to a next land is designated by 2Tp.

In addition, Fp denotes a “defocus interval” defined as an interspace between a positive side peak and a negative side peak of a focus error signal having an S-letter characteristic.

This “defocus interval” ranges from −0.008 μm to 0.008 μm in FIG. 8, for example, and is defined by a focal distance of the objective lens 26, a size of each optical receiving region of the photodetector 11, or the like.

In this manner, in the track pitch Tp which meets formula (4), a change rate leaking to a focus error signal is obtained as a level which can be practically ignored.

FIG. 9 is a graph depicting formula (4), where the horizontal axis indicates a detection range of a focus error.

In FIG. 9, a curve “a” corresponds to a DVD-RAM disk which conforms to a current DVD standard. That is, the curve “a” indicates Tp=0.615 μm and NA=0.6 (the wavelength λ of the laser beam is λ=60 nm). In addition, a curve “b” assumes a rewritable disk which conforms to an HD DVD standard using a laser beam having a wavelength of 405 nm, where Tp=0.34 μm and NA=0.65. A curve “c” indicates a result obtained by applying another standard using a laser beam having a wavelength of 405 nm (a standard called Blu-ray in which aperture number of an objective lens is NA=0.85, and a track pitch Tp is 0.32 μm.

From formula (4), as long as the detection range of a focus is equal to or greater than 3.4 μm in the case of a DVD-RAM and as long as the detection range is equal to or greater than 1.75 μm in the case of an HD DVD rewritable disk, even if a track error signal leaks to a focus error signal, it is observed that effect of a change of the focus error signal is reduced. In FIG. 9, a curve “d” indicates a result obtained by computation (simulation) of a focus detection range in accordance with formula (4) from a track pitch (0.08 μm) and NA (NA=2.3) using an SIL (Solid Immersion Lens) which is currently under research and development.

As described above, in an optical pickup device according to the present invention, the focus error detection range for detecting a focus error has been widened more significantly than a defocus range in which a magnitude of a focus error signal is changed by the leakage of a track error signal (or track-cross signal), whereby, even if the focus error signal has changed, stable focus control is achieved. That is, the detection range of a focus error has been widened more significantly than a change range of a focus error signal, whereby effect of the change can be reduced. (The effect of the change used here denotes that, even if a defocus quantity is substantially kept unchanged, a level of the focus error signal changes depending on a position on an optical disk on which an optical spot is tracing (is irradiated) (depending on whether there exists a position affected by diffraction from a track).)

In addition, when an objective lens for focusing a light beam from a light source on a recording layer of a recording medium and capturing the light beam reflected in the recording layer is moved so that a distance between the objective lens and the recording medium coincides with a focusing position of light beams focused on the recording medium by means of the objective lens based on an output of an optical detector for outputting an electrical signal of a magnitude which corresponds to intensity of the reflection light beam in the recording layer captured by the objective lens, control of a position in a focus direction of the objective lens is stabilized by setting the range for detecting an output from the optical detector for controlling a position of the objective lens in a range which is wider than a range in which a magnitude of an error signal for controlling a position of the objective lens is changed by a leakage signal component generated when the objective lens is moved in a direction which crosses a track of the recording medium, and then, by reducing effect of the leakage signal component generated when the objective lens for detecting the output of the optical detector for controlling the position of the objective lens is moved in the direction which crosses the track of the recording medium.

In the above-described embodiments, a divisional pattern of a luminous flux by a hologram is provided as an example without being limited thereto. In addition, while the embodiments have described an example of defining a hologram as a type of dividing and deflecting the luminous flux and using only a partial luminous flux of the reflection light beams from an optical disk for a focus error signal, the present invention can be applied in a system of using either of a 0th-order light beam and a ±1st-order light beam of the whole diffraction without dividing the luminous flux.

In addition, while an knife edge technique has been described as a method for detecting a focus (obtaining a focus error signal) by way of example, a non-point aberration technique utilizing non-point aberration or a spot size technique utilizing a change of a spot size, or other techniques can also be applied as a focus detecting method.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical pickup device comprising:
a light source which outputs a light beam having a predetermined wavelength;
an objective lens which focuses the light beam from the light source in a recording layer of a recording medium and which captures a light beam reflected in the recording layer;
an optical detector which converts to an electrical signal the light beam reflected in the recording layer, the light being captured by means of the objective lens and which outputs an electrical signal of a magnitude which corresponds to optical intensity; and
a lens position control unit which controls a position of the objective lens so that a distance between the objective lens and the recording medium coincides with a focusing position of the light beam focused in the recording medium by means of the objective lens, based on an output of the optical detector,
wherein the lens position control unit is such that a range for detecting an output from the optical detector for controlling a position of the objective lens is set in a range which is wider than a range in which a magnitude of an error signal for controlling a position of the objective lens is changed by a leakage signal component generated when the objective lens is moved in a direction which crosses a track of the recording medium.

2. The optical pickup device according to claim 1,
wherein, when a track pitch of the recording medium is Tp, a numerical aperture of the objective lens is NA, and the detection range is Fp, the detection range (Fp) is defined in a range of 2Tp/(NA×Fp)≦0.6.

3. The optical pickup device according to claim 2,
wherein a wavelength of a light beam from the light source is preferably 400 nm to 410 nm.

4. The optical pickup device according to claim 2,
wherein the numerical aperture of the objective lens is 0.65.

5. The optical pickup device according to claim 3,
wherein the numerical aperture of the objective lens is preferably 0.65.

6. An information recording and reproducing apparatus comprising:
an optical pickup device having: a light source which outputs a light beam having a predetermined wavelength; an objective lens which focuses the light beam from the light source in a recording layer of a recording medium and which captures the light beam reflected in the recording layer; an optical detector which converts to an electrical signal the light beam reflected in the recording layer, the light being captured by means of the objective lens and which outputs an electrical signal of a magnitude which corresponds to optical intensity; and a lens position control unit which controls a position of the objective lens so that a distance between the objective lens and the recording medium coincides with a focusing position of the light beam focused in the recording medium by means of the objective lens, based on an output of the optical detector;
an output signal processor circuit which captures information recorded in the recording medium from a reflection light beam from the recording medium, the reflection light beam being detected by the optical detector; and
a main control unit which controls operations of the optical pickup device and the output signal processor circuit,
wherein the lens position control unit is such that a range for detecting an output from the optical detector for controlling a position of the objective lens is set in a range which is wider than a range in which a magnitude of an error signal for controlling a position of the objective lens is changed by a leakage signal component generated when the objective lens is moved in a direction which crosses a track of the recording medium.

7. The information recording and reproducing apparatus according to claim 6,
wherein, when a track pitch Tp of the recording medium is, a numerical aperture of the objective lens is NA, and the detection range is Fp, the detection range (Fp) is defined in a range of 2Tp/(NA×Fp)≦0.6.

8. The information recording and reproducing apparatus according to claim 7,
wherein a wavelength of a light beam from the light source is preferably 400 nm to 410 nm.

9. The information recording and reproducing apparatus according to claim 7,
wherein the numerical aperture of the objective lens is 0.65.

10. The information recording and reproducing apparatus according to claim 8,
wherein the numerical aperture of the objective lens is preferably 0.65.

11. A method of controlling position of objective lens which focuses a light beam from a light source in a recording layer of a recording medium and captures a light source reflected in the recording layer so that a distance between the objective lens and the recording medium coincides with a focusing position of the light beam focused in the recording medium by means of the objective lens, based on an output of an optical detector which outputs an electrical signal of a size corresponding to intensity of the reflection light beam in the recording layer, the reflection light being captured by means of the objective lens, the method comprising:
setting a range for detecting the output of the optical detector for controlling the position of the objective lens in a range which is wider than a range in which a magnitude of an error signal for controlling the position of the objective lens by a leakage signal component generated when the objective lens is moved in a direction which crosses a track; and
reducing effect of the leakage signal component generated when the objective lens for detecting the output from the optical detector for controlling the position of the objective lens is moved in the direction which crosses the track of the recording medium.
